(19) United States
(12) Patent Application Publication
(10) Pub. No.: US 2015/0327295 A1
(43) Pub. Date: Nov. 12, 2015

(54) INTER RADIO ACCESS TECHNOLOGY MEASUREMENT GAP

(71) Applicant: QUALCOMM Incorporated, San Diego, CA (US)

(72) Inventors: Ming YANG, San Diego, CA (US); Tom CHIN, San Diego, CA (US); Guangming SHI, San Diego, CA (US)

(73) Assignee: QUALCOMM Incorporated, San Diego, CA (US)

(21) Appl. No.: 14/275,670

(22) Filed: May 12, 2014

(51) Int. Cl. H04W 72/14; H04W 72/04

(52) U.S. Cl. CPC H04W 72/14; H04W 72/0446

(57) ABSTRACT

A method of wireless communication includes receiving a data grant for multiple retransmission time slots associated with successfully decoded high speed data. The grant is in response to a base station detecting a NACK. The method also includes tuning away from a serving cell during the retransmission time slots.

### BACKGROUND

1. Field

Aspects of the present disclosure relate generally to wireless communication systems, and more particularly, to improving the creation of a gap for inter radio access technology (IRAT) measurements.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA), that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

In one aspect of the present disclosure, a method of wireless communication is disclosed. The method includes receiving a data grant for multiple retransmission time slots associated with successfully decoded high speed data in response to a base station detecting a negative acknowledgement. The method also includes tuning away from a serving cell during the retransmission time slots.

Another aspect of the present disclosure is directed to an apparatus including means for receiving a data grant for multiple retransmission time slots associated with successfully decoded high speed data in response to a base station detecting a negative acknowledgement. The apparatus also includes means for tuning away from a serving cell during the retransmission time slots.

In another aspect of the present disclosure, a computer program product for wireless communications in a wireless network having a non-transitory computer-readable medium is disclosed. The computer readable medium has non-transitory program code recorded thereon which, when executed by the processor(s), causes the processor(s) to perform operations of receiving a data grant for multiple retransmission time slots associated with successfully decoded high speed data in response to a base station detecting a negative acknowledgement. The program code also causes the processor(s) to tune away from a serving cell during the retransmission time slots.

Another aspect of the present disclosure is directed to an apparatus for wireless communications having a memory and at least one processor coupled to the memory. The processor(s) is configured to receive a data grant for multiple retransmission time slots associated with successfully decoded high speed data in response to a base station detecting a negative acknowledgement. The processor(s) is also configured to tune away from a serving cell during the retransmission time slots.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates network coverage areas according to aspects of the present disclosure.

FIG. 5 illustrates a call flow diagram for receiving a grant via the high-speed shared control channel according to an aspect of the present disclosure.

FIG. 6 illustrates a flow diagram for processing a received grant according to an aspect of the present disclosure.

FIG. 7 illustrates a flow diagram for tuning away from a serving cell during a data retransmission according to an aspect of the present disclosure

FIG. 8 is a block diagram illustrating a method for tuning away from a serving cell according to one aspect of the present disclosure.

FIG. 9 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

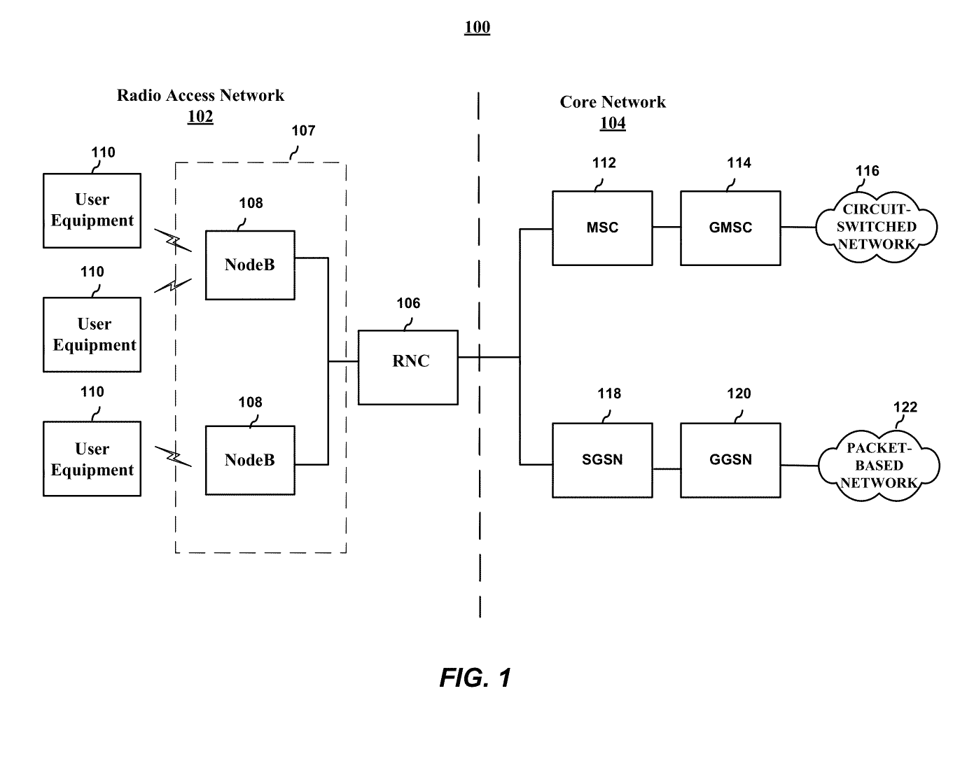

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

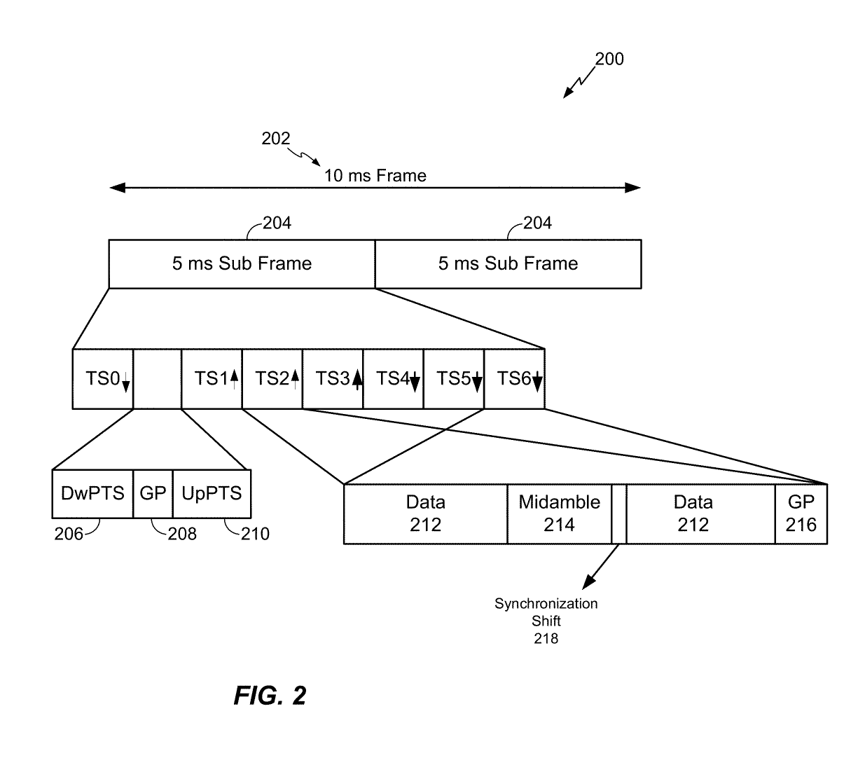

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

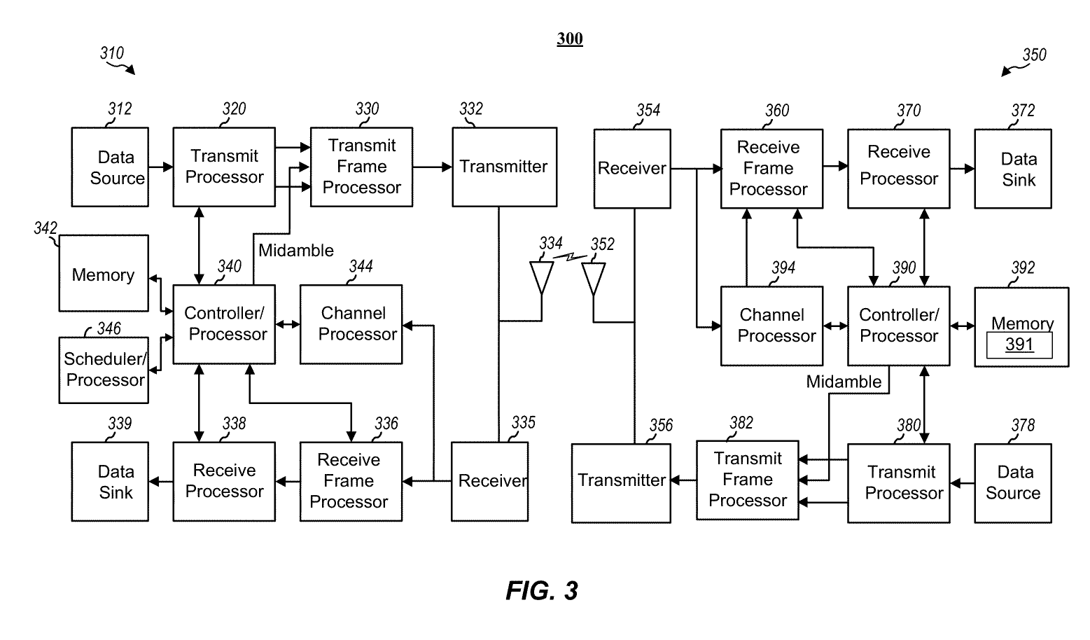

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store a measurement gap module 391 which, when executed by the controller/processor 390, configures the UE 350 for tuning away from a serving cell during the plurality of retransmission time slots associated with successfully decoded high speed data in response to a base station detecting a NACK A scheduler/processor 346 at the node B 310 may be used to allocate resources to the UEs and schedule downlink and/or uplink transmissions for the UEs.

The computer readable media of memories 392 may store data and software for the UE 350. For example, the memory 392 of the UE 350 may store a gap management module 391 which, when executed by the controller/processor 390, configures the UE 350 for extending a measurement gap.

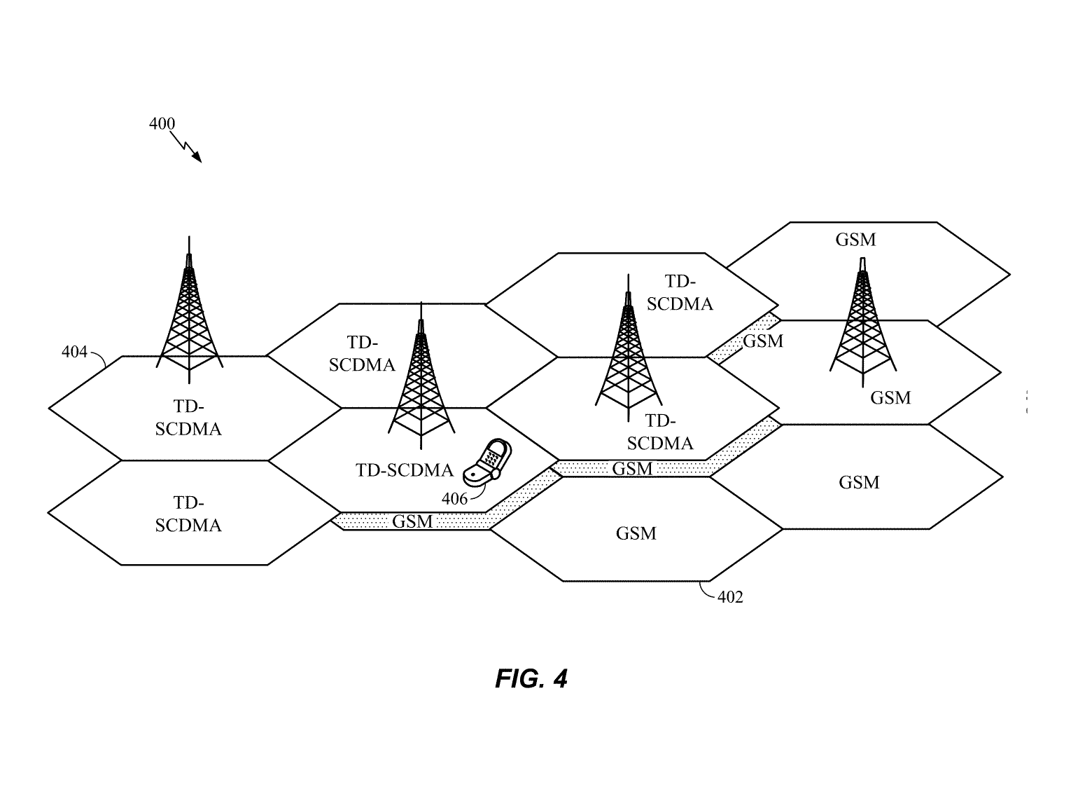

Some networks, such as a newly deployed network, may cover only a portion of a geographical area. Another network, such as an older more established network, may better cover the area, including remaining portions of the geographical area. FIG. 4 illustrates coverage of a newly deployed network, such as a TD-SCDMA network and also coverage of a more established network, such as a GSM network. A geographical area 400 may include GSM cells 402 and TD-SCDMA cells 404. A user equipment (UE) 406 may move from one cell, such as a TD-SCDMA cell 404, to another cell, such as a GSM cell 402. The movement of the UE 406 may specify a handover or a cell reselection.

Handover from a first radio access technology (RAT) to a second RAT may occur for several reasons. First, the network may prefer to have the user equipment (UE) use the first RAT as a primary RAT but use the second RAT simply for voice service(s). Second, there may be coverage holes in the network of one RAT, such as the first RAT.

Handover from the first RAT to the second RAT may be based on event 3A measurement reporting. In one configuration, the event 3A measurement reporting may be triggered based on filtered measurements of the first RAT and the second RAT, a base station identity code (BSIC) confirm procedure of the second RAT and also a BSIC re-confirm procedure of the second RAT. For example, a filtered measurement may be a Primary Common Control Physical Channel (P-CCPCH) or a Primary Common Control Physical Shared Channel (P-CCPSCH) received signal code power (RSCP) measurement of a serving cell. Other filtered measurements can be of a received signal strength indication (RSSI) of a cell of the second RAT.

The initial BSIC identification procedure occurs because there is no knowledge about the relative timing between a cell of the first RAT and a cell of the second RAT. The initial BSIC identification procedure includes searching for the BSIC and decoding the BSIC for the first time. The UE may trigger the initial BSIC identification within available idle time slot(s) when the UE is in a dedicated channel (DCH) mode configured for the first RAT.

The UE maintains timing information of some neighbor cells, e.g., at least eight identified GSM cells in one configuration. The timing information may be useful for inter-radio access technology (IRAT) handover to one of the neighbor cells (e.g., target neighbor cell) and may be obtained from the BSIC. For example, initial timing information of the neighbor cells may be obtained from an initial BSIC identification. The timing information may be updated every time the BSIC is decoded.

### High Speed Data Networks

High speed networks improve uplink and downlink throughput. In particular, high speed downlink packet access (HSDPA) and time division high speed downlink packet access (TD-HSDPA) are enhancements to time division synchronous code division multiple access (TD-SCDMA), improving downlink throughput. Additionally, high speed uplink packet access (HSUPA) and time division high speed uplink packet access (TD-HSUPA) are enhancements to time division synchronous code division multiple access (TD-SCDMA), improving uplink throughput.

The following describes various TD-HSDPA physical channels. The high-speed physical downlink shared channel (HS-PDSCH) carries a user data burst(s). The high-speed shared information channel (HS-SICH) is also referred to as the feedback channel. The HS-SICH carries the channel quality index (CQI), the recommended transport block size (RTBS) and the recommended modulation format (RMF). Additionally, the HS-SICH also carries the HARQ ACK/NACK of the HS-PDSCH transmissions.

The high-speed shared control channel (HS-SCCH), also referred to as the grant channel, carries the modulation and coding scheme, channelization code, time slot and transport block size information for the data burst in HS-PDSCH. The high-speed shared control channel also carries the HARQ process, redundancy version, and new data indicator information for the data burst. Additionally, the high-speed shared control channel carries the high-speed shared control channel cyclic sequence number, which increments a UE specific cyclic sequence number for each high-speed shared control channel transmission. Further, the high-speed shared control channel carries the UE identity to indicate which UE should receive the data burst allocation.

The high-speed shared control channel may include a UE H-RNTI that is masked on the CRC attachment. Furthermore, the high-speed shared control channel may include an 8-bit channelization code set specifying which set of the 16 spreading factor (SF16) codes is used; a 5-bit time slot info specifying which time slot is scheduled; a 1-bit modulation scheme; a 6-bit TB size index that specifies 64 different block sizes; a 3-bit HARQ process ID; a 3-bit for redundancy information; a 1-bit new data indication; and a 3-bit high-speed shared control channel cyclic sequence number (CSN).

Each high-speed shared control channel specifies the high-speed physical downlink shared channel allocation in the next subframe. In one configuration, the high-speed shared control channel is the two subframes (subframe n+2) following the high-speed physical downlink shared channel transmission. The high-speed shared control channel is associated with one high-speed shared information channel. The association between the high-speed shared control channel on the downlink and high-speed shared information channel on the uplink may be pre-defined by higher layers.

The operation of TD-HSUPA may also have the following steps. First, in the resource request step, the UE sends requests (e.g., via scheduling information (SI)) via the E-PUCH or the E-RUCCH to a base station (e.g., NodeB). The requests are for permission to transmit on the uplink channels. Next, the base station, which controls the uplink radio resources, allocates resources. Resources are allocated in terms of scheduling grants (SGs) to individual UEs based on their requests. In the third step (i.e., the UE Transmission step), the UE transmits on the uplink channels after receiving grants from the base station. The UE determines the transmission rate and the corresponding transport format combination (TFC) based on the received grants. The UE may also request additional grants if it has more data to transmit. Finally, in the fourth step (i.e., the base station reception step), a hybrid automatic repeat request (hybrid ARQ or HARQ) process is employed for the rapid retransmission of erroneously received data packets between the UE and the base station.

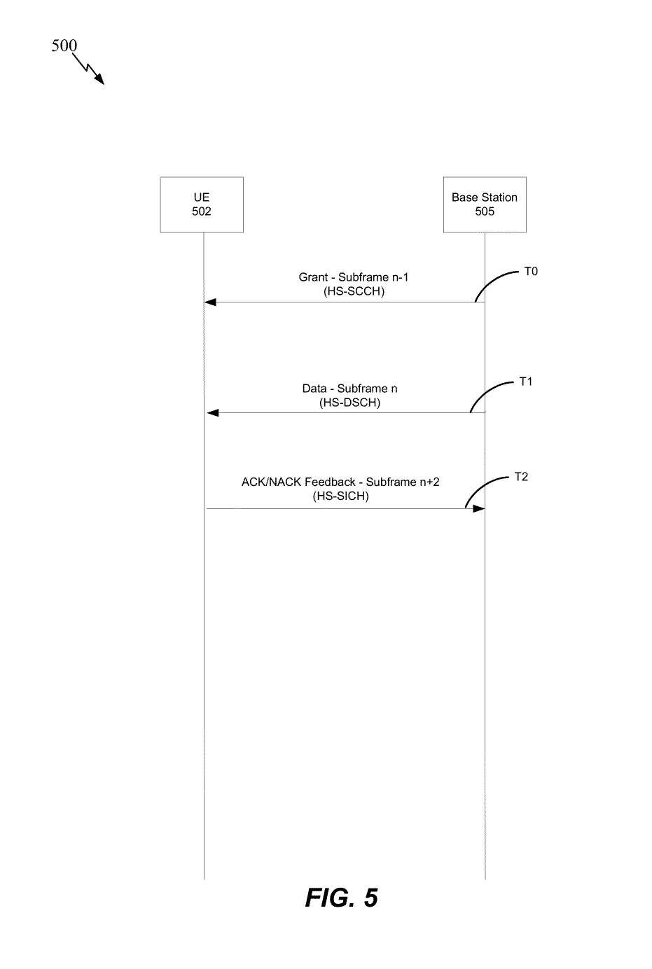

FIG. 5 illustrates an example 500 of receiving a grant via the high-speed shared control channel. As shown in FIG. 5, at time T0, a UE 502 receives a grant via the high-speed shared control channel on subframe n−1. The grant may indicate a new data transmission or a data retransmission. Furthermore, at time T1, the UE 502 receives a data transmission via a data channel, such as the high-speed downlink shared channel, on subframe n. The data is transmitted based on the grant received in subframe n−1. Furthermore, after receiving the data transmission, at time T2, the UE 502 may transmit ACK/NACK feedback to the base station 505 on subframe n+2. The ACK/NACK feedback is transmitted via the high-speed shared information channel. As previously discussed, the high-speed shared information channel is two subframes (subframe n+2) after the high-speed downlink shared channel transmission.

Improved Measurement Gap Creation

Typically, after a UE has successfully decoded a data transmission received on a data channel, such as a high-speed data channel, the HARQ buffer is empty. Thus, if the HARQ buffer is empty and the UE receives a grant indicating a retransmission, the UE does not decode the data retransmitted via the data channel in the subframe following the grant. Rather, the UE may use one or more time slots allocated for the data retransmission to tune away from the serving cell. In one configuration, the UE may use the allocated time slots for an inter-RAT measurement if there are no other channels allocated in these time slots. Even though the UE successfully decoded the previous data transmission, the network may transmit the data retransmission grant because the acknowledgement (ACK) was either missed by the network or mis-detected by network as a negative acknowledgement (NACK).

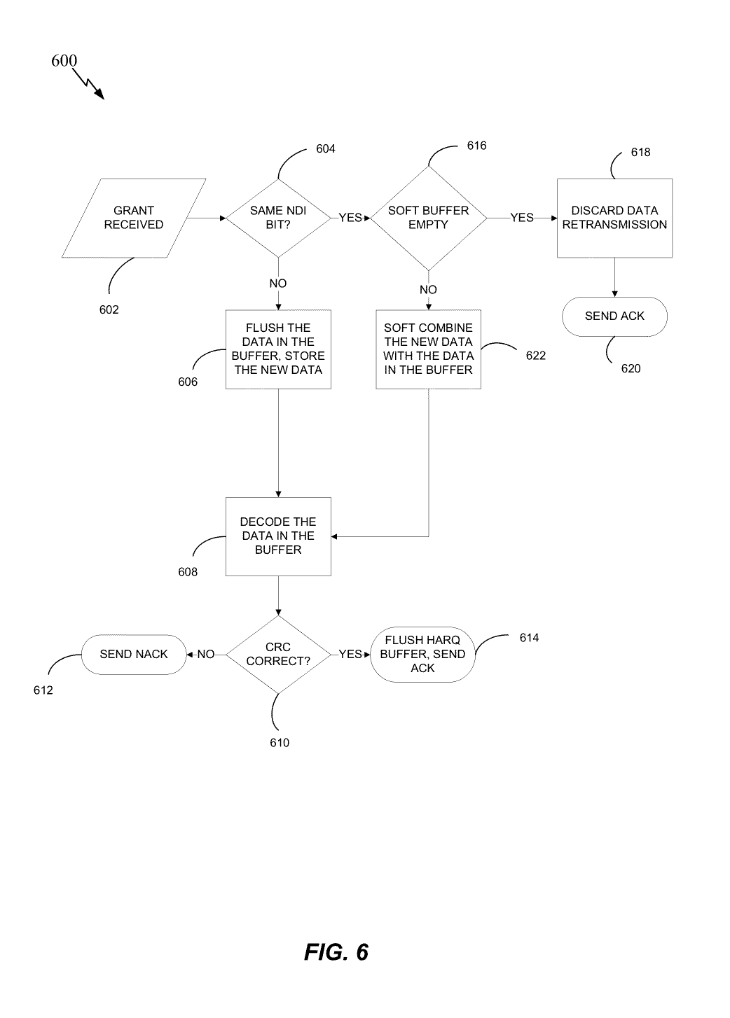

FIG. 6 illustrates a flow diagram 600 for processing a received grant according to an aspect of the present disclosure. As shown in FIG. 6, at block 602, a UE receives a grant. As previously discussed the grant may be received on a control channel, such as a high-speed shared control channel. After receiving the grant, at block 604, the UE determines if a new data indicator (NDI) bit of the grant is the same as a previous new data indicator bit. If the new data indictor bit is not the same, the UE determines that the data transmission grant is for a new data transmission. Alternatively, if the new data indictor bit is the same, the UE determines that the data transmission grant is for a data retransmission.

As shown in FIG. 6, when the new data indicator is not the same, at block 606, the UE flushes any data stored in the buffer and stores the new data that was transmitted after receiving the grant (block 602). Furthermore, at block 608, the UE attempts to decode the data stored at block 606. Additionally, after attempting to decode the data (block 608), the UE determines if a cyclic redundancy code (CRC) of the decoded data is correct (block 610). If the CRC is not correct, the UE transmits a NACK to the base station at block 612. Alternatively, if the CRC is correct, the UE flushes the HARQ buffer and transmits an ACK to the base station at block 614.

As previously discussed, after receiving the grant, at block 604, the UE determines if the new data indicator (NDI) bit of the grant is the same as the previous new data indicator bit. After determining that the new data indicator bit is the same, at block 616, the UE determines if the soft buffer is empty. An empty soft buffer may indicate that the transmitted data was successfully decoded. Alternatively, if the soft buffer is not empty, the UE may not have successfully decoded a previous data transmission.

As shown in FIG. 6, if the UE determines that the soft buffer is empty (block 616), at block 618, the UE will discard the data retransmission. Furthermore, because the UE has already successfully decoded a previous data transmission, the UE still transmits an ACK to the base station (block 620) to acknowledge the data retransmission. In one configuration, the UE performs an inter-RAT measurement when the base station is performing the data retransmission.

Furthermore, as shown in FIG. 6, if the soft buffer is not empty (block 616), at block 622, the UE performs a soft-combination of the new data with data that is already in the buffer. After performing the soft combination (block 622), at block 608 the UE attempts to decode the data after soft combining Additionally, after attempting to decode the data (block 608), the UE determines if the CRC of the decoded data is correct (block 610). If the CRC is not correct, the UE transmits a NACK to the base station at block 612. Alternatively, if the CRC is correct, the UE flushes the HARQ buffer and transmits an ACK to the base station at block 614.

In some cases, when a UE is leaving the coverage of a cell, such as a TD-SCDMA cell, during a high speed transmission, a sufficient number of idle time slots may not be available for the UE to perform an inter-RAT measurement. More specifically, a reduced number of idle time slots may be present when consecutive high speed grants and high speed data transmission are present on every subframe. The inter-RAT measurements may be performed for a GSM received signal strength indicator (RSSI), frequency control channel (FCCH) blind detection, and/or synchronization channel (SCH) base station identity code (BSIC) confirmation and reconfirmation.

In some cases, due to the insufficient number of idle time slots, the UE cannot perform an inter-RAT measurement until a call is dropped, even if a strong GSM cell is available for a handover. Various techniques may be specified for creating a gap for an inter-RAT measurement. For example, a UE forced gap may be specified. As another example, the UE may disable receiving and/or transmitting while the network performs a transmission. Still, the aforementioned methods may result in data loss.

As previously discussed, the UE may successfully decode a high speed downlink shared channel transmission and transmit an ACK to the network. Still, the network may mis-detect the ACK as a NACK or the network may not receive the ACK. Therefore, the network may transmit a grant indicating a retransmission even though the original transmission was successfully decoded. According to an aspect of the present disclosure, when a UE receives a grant indicating retransmission and a HARQ buffer is empty, the UE uses one or more time slots allocated for a high speed downlink shared channel retransmission to tune away from the serving cell. In one configuration, the UE tunes away to perform an inter-RAT measurement. As previously discussed, the empty HARQ buffer may indicate that the UE has successfully decoded the previous data transmission.

Additionally, in one configuration, the UE uses one or more time slots allocated for high speed downlink shared channel retransmission for an inter-RAT measurement if no other channels are scheduled in the time slots allocated for the high speed downlink shared channel retransmission and when a serving cell signal quality is below a predefined threshold, a traffic time slot signal to noise ratio is below a predefined threshold, and/or a transmission power is above a predefined threshold.

In another configuration, the UE forces a retransmission grant to create a measurement time slot. That is, after successfully decoding a high speed downlink shared channel, the UE may transmit a NACK instead of an ACK. The transmitted NACK causes the base station to transmit a retransmission grant even though the original transmission was successfully decoded. Thus, the UE may use one or more time slots allocated for high speed downlink shared channel retransmission to tune away from the serving cell. The UE may determine a number of NACKs to transmit based on the number of time slots desired for performing a tune away from the serving cell. As previously discussed, the UE may use time slots allocated for a high speed downlink shared channel for inter-RAT measurement if there are no other channels scheduled in these time slots.

In one configuration, the timing of when the NACK is sent is based on when a measurement gap should occur. This timing is based on a timing of channels to be measured for a target radio access technology (RAT). For example, if the UE expects the target RAT to transmit a particular channel 1 second from now, the NACK is transmitted enough time before the 1 second to enable tuning to the target RAT in time to receive the channel to be measured.

Aspects of the present disclosure have discussed the UE tuning away from the serving cell to perform inter-RAT measurements during one or more time slots allocated for high speed downlink shared channel retransmission. Still, aspects of the present disclosure are not limited to the UE performing inter-RAT measurements during the aforementioned time slots. Additionally, or alternatively, during one or more time slots allocated for high speed downlink shared channel retransmission, the UE may tune away from the serving cell and perform an inter-frequency measurement and/or activity for a second subscriber identity module (SIM) of the UE. The activity for the second SIM may include page monitoring, system information block (SIB) acquisition, cell reselection, re-acquisition and/or acquisition. Acquisition may refer to the second SIM detecting a cell after an initial power on and camping on the detected cell.

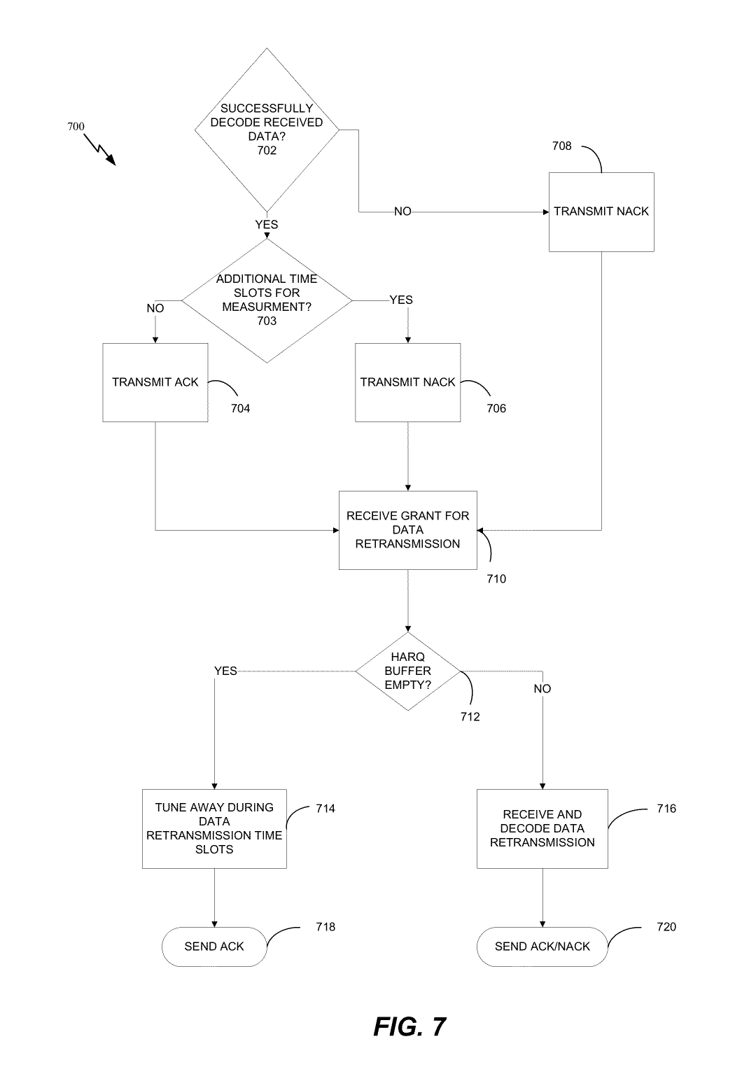

FIG. 7 illustrates a flow diagram 700 for tuning away from a serving cell during a data retransmission according to an aspect of the present disclosure. At block 702, a UE determines whether data has been successfully decoded. If the data is successfully decoded, the UE either transmits an ACK (block 704) or the UE transmits a NACK (block 706), based on whether additional measurement time slots are desired (block 703). In one configuration, the UE transmits the NACK to force a data retransmission if additional time slots are desired. The UE may transmit the NACK based on a need for one or more time slots to tune away from the serving cell. Alternatively, if the UE does not successfully decode the data, the UE transmits a NACK (block 708) and waits for a data retransmission grant.

As shown in FIG. 7, at block 710, the UE may receive a grant for a data retransmission. In one configuration, the data retransmission is a high speed downlink shared channel retransmission. The UE receives the grant for a data retransmission when the base station receives a NACK from the UE, when the base station mis-detects an ACK as a NACK, or when the base station does not receive the ACK. As previously discussed, the UE may transmit a NACK to force a data retransmission (block 706) or the UE may transmit a NACK when the data was not successfully decoded (block 708). Mis-detection or non-reception of the ACK occurs in response to the ACK sent in block 704.

Upon receiving the grant, the UE determines whether the HARQ buffer is empty (block 712). That is, the empty HARQ buffer indicates that the previous data transmission was successfully decoded. If the HARQ buffer is empty, the UE uses one or more time slots allocated for high speed downlink shared channel retransmission to tune away from the serving cell (block 714). Alternatively, if the HARQ buffer is not empty, the UE does not tune away from the serving cell so that the UE may receive and attempt to decode the high speed downlink shared channel retransmission (block 716).

In one configuration, in addition to determining whether the HARQ buffer is empty to perform a tune away from the serving cell (block 716), the UE also determines whether other channels are scheduled in the time slots allocated for the high speed downlink shared channel retransmission and whether a serving cell signal quality is below a predefined threshold, a traffic time slot signal to noise ratio is below a predefined threshold, and/or a transmission power is above a predefined threshold.

Furthermore, as shown in FIG. 7, after tuning away from the serving cell (block 714), the UE tunes back to the serving cell and transmits an ACK (block 718) in response to the data retransmission. That is, because the UE has successfully decoded the previous data transmission, the UE still transmits an ACK (block 718) even though the UE tuned away during the data retransmission. Furthermore, if the UE receives the data retransmission, at block 716, the UE transmits an ACK or a NACK (block 720) based on whether the UE successfully decoded the data retransmission.

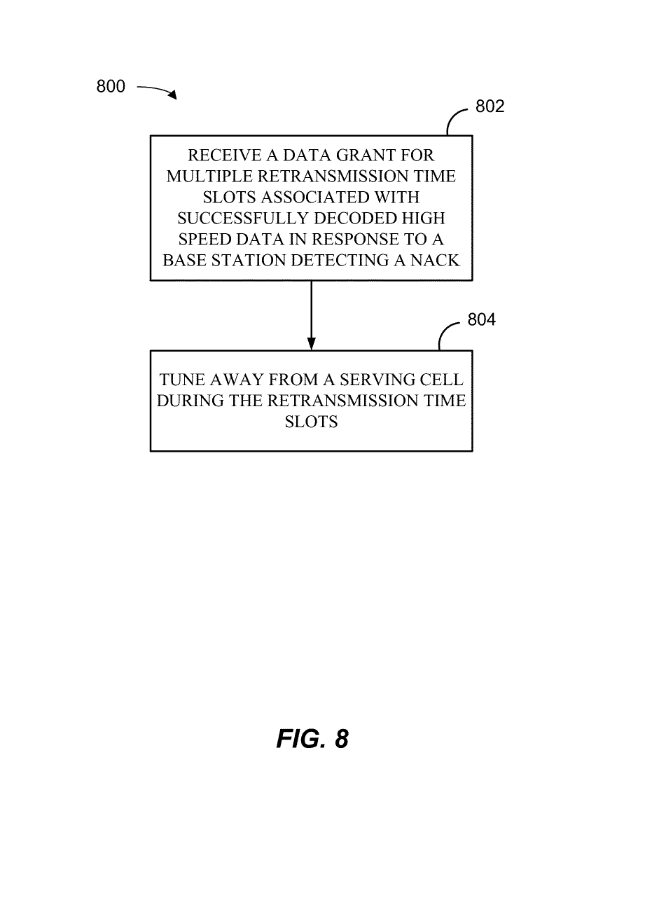

FIG. 8 shows a wireless communication method 800 according to one aspect of the disclosure. A UE receives a data grant for multiple retransmission time slots associated with successfully decoded high speed data in response to a base station detecting a NACK, as shown in block 802. The UE tunes away from a serving cell during the retransmission time slots, as shown in block 804.

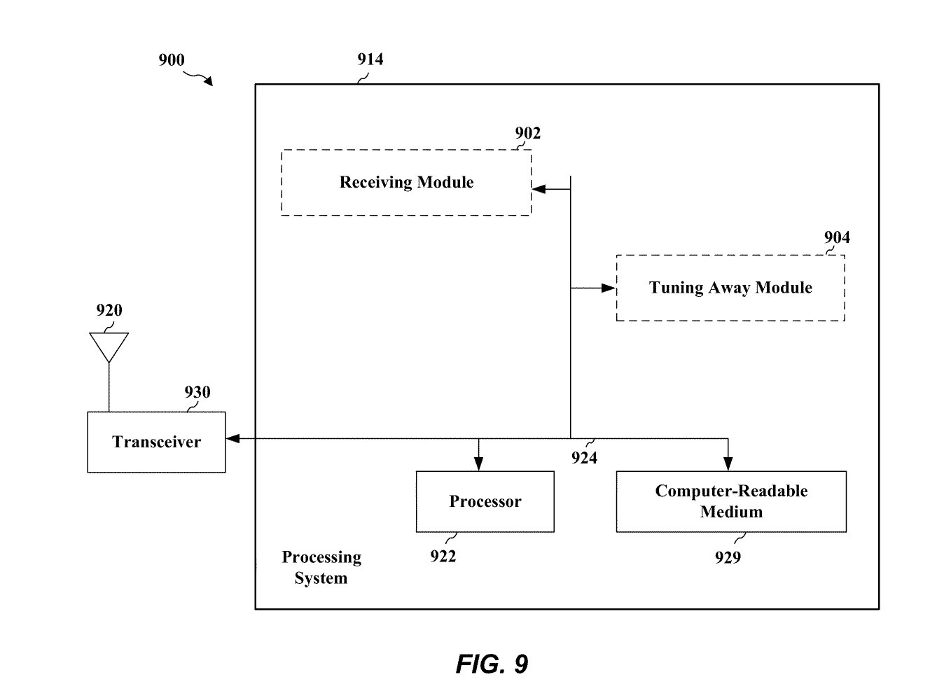

FIG. 9 is a diagram illustrating an example of a hardware implementation for an apparatus 900 employing a processing system 914. The processing system 914 may be implemented with a bus architecture, represented generally by the bus 924. The bus 924 may include any number of interconnecting buses and bridges depending on the specific application of the processing system 914 and the overall design constraints. The bus 924 links together various circuits including one or more processors and/or hardware modules, represented by the processor 922 the modules 902, 904, and the non-transitory computer-readable medium 929. The bus 924 may also link various other circuits such as timing sources, peripherals, voltage regulators, and power management circuits, which are well known in the art, and therefore, will not be described any further.

The apparatus includes a processing system 914 coupled to a transceiver 930. The transceiver 930 is coupled to one or more antennas 920. The transceiver 930 enables communicating with various other apparatus over a transmission medium. The processing system 914 includes a processor 922 coupled to a non-transitory computer-readable medium 929. The processor 922 is responsible for general processing, including the execution of software stored on the computer-readable medium 929. The software, when executed by the processor 922, causes the processing system 914 to perform the various functions described for any particular apparatus. The computer-readable medium 929 may also be used for storing data that is manipulated by the processor 922 when executing software.

The processing system 914 includes a receiving module 902 for receiving a data grant for one or more retransmission time slots associated with successfully decoded high speed data in response to a base station detecting a NACK. The processing system 914 includes a tuning away module 904 for tuning away from a serving cell during the retransmission time slot(s). The modules may be software modules running in the processor 922, resident/stored in the computer readable medium 929, one or more hardware modules coupled to the processor 922, or some combination thereof. The processing system 914 may be a component of the UE 350 and may include the memory 392, and/or the controller/processor 390.

In one configuration, an apparatus such as a UE is configured for wireless communication including means for receiving. In one aspect, the receiving means may be the antennas 352, the receiver 354, the channel processor 394, the receive frame processor 360, the receive processor 370, the controller/processor 390, the memory 392, the measurement gap module 391, receiving module 902, and/or the processing system 914 configured to perform the receiving. The UE is also configured to include means for tuning away. In one aspect, the tuning away means may be the antennas 352, the receiver 354, the channel processor 394, the receive frame processor 360, the receive processor 370, the controller/processor 390, the memory 392, the measurement gap module 391, the tuning away module 904 and/or the processing system 914 configured to perform the tuning away. In one aspect the means functions recited by the aforementioned means. In another aspect, the aforementioned means may be a module or any apparatus configured to perform the functions recited by the aforementioned means.

Several aspects of a telecommunications system has been presented with reference to TD-SCDMA and GSM, and other high speed systems. As those skilled in the art will readily appreciate, various aspects described throughout this disclosure may be extended to other telecommunication systems, network architectures and communication standards. By way of example, various aspects may be extended to other UMTS systems such as W-CDMA, High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
receiving a data grant for a plurality of retransmission time slots associated with successfully decoded high speed data in response to a base station detecting a negative acknowledgement (NACK); and
tuning away from a serving cell during the plurality of retransmission time slots.

2. The method of claim 1, further comprising transmitting, by a UE, an acknowledgement (ACK) that is mis-detected by the base station as the NACK.

3. The method of claim 1, further comprising transmitting, by a UE, the NACK, after successfully decoding high speed data, in order to use the plurality of retransmission time slots to tune away from the serving cell.

4. The method of claim 3, in which a number of NACKs are generated based at least in part on a desired measurement gap length.

5. The method of claim 3, in which the NACK is sent based at least in part on when a measurement gap should occur according to a timing of channels to be measured for a target radio access technology (RAT).

6. The method of claim 1, in which the performing only occurs when no other physical channels are allocated to the plurality of retransmission time slots.

7. The method of claim 1, further comprising performing one or more of an inter-radio access technology (IRAT) measurement, an inter-frequency measurement, activity for a second subscriber identity module (SIM), or a combination thereof, after the tune away from the serving cell.

8. The method of claim 7, in which activity for the second SIM comprises one or more of page monitoring, system information block (SIB) collection, cell reselection, acquisition and re-acquisition, or a combination thereof.

9. An apparatus for wireless communication, the apparatus comprising:
a memory unit; and
at least one processor coupled to the memory unit, the at least one processor being configured:
to receive a data grant for a plurality of retransmission time slots associated with successfully decoded high speed data in response to a base station detecting a negative acknowledgement (NACK); and
to tune away from a serving cell during the plurality of retransmission time slots.

10. The apparatus of claim 9, in which the at least one processor is further configured to transmit an acknowledgement (ACK) that is mis-detected by the base station as the NACK.

11. The apparatus of claim 9, in which the at least one processor is further configured to transmit the NACK, after successfully decoding high speed data, in order to use the plurality of retransmission time slots to tune away from the serving cell.

12. The apparatus of claim 11, in which a number of NACKs are generated based at least in part on a desired measurement gap length.

13. The apparatus of claim 11, in which the NACK is sent based at least in part on when a measurement gap should occur according to a timing of channels to be measured for a target radio access technology (RAT).

14. The apparatus of claim 9, in which the performing only occurs when no other physical channels are allocated to the plurality of retransmission time slots.

15. The apparatus of claim 9, in which the at least one processor is further configured to perform one or more of an inter-radio access technology (IRAT) measurement, an inter-frequency measurement, activity for a second subscriber identity module (SIM), or a combination thereof, after the tune away from the serving cell.

16. The apparatus of claim 15, in which activity for the second SIM comprises one or more of page monitoring, system information block (SIB) collection, cell reselection, acquisition and re-acquisition, or a combination thereof.

17. A computer program product for wireless communications, the computer program product comprising:
a non-transitory computer-readable medium having program code recorded thereon, the program code comprising:
program code to receive a data grant for a plurality of retransmission time slots associated with successfully decoded high speed data in response to a base station detecting a negative acknowledgement (NACK); and
program code to tune away from a serving cell during the plurality of retransmission time slots.

18. The computer program product of claim 17, in which the program code further comprises program code to transmit an acknowledgement (ACK) that is mis-detected by the base station as the NACK.

19. The computer program product of claim 17, in which the program code further comprises program code to transmit the NACK, after successfully decoding high speed data, in order to use the plurality of retransmission time slots to tune away from the serving cell.

20. The computer program product of claim 19, in which a number of NACKs are generated based at least in part on a desired measurement gap length.
